(19) United States
(12) Patent Application Publication
(10) Pub. No.: US 2020/0082359 A1
(43) Pub. Date: Mar. 12, 2020

(54) Evaluating Blockchain Computer Protocols

(71) Applicant: Nebulas IO Limited, Road Town (VG)

(72) Inventor: Yiji Xu, Beijing (CN)

(21) Appl. No.: 16/125,568

(22) Filed: Sep. 7, 2018

(51) Int. Cl. G06Q 20/06; H04L 29/06

(52) U.S. Cl. CPC G06Q 20/065; H04L 9/3236; H04L 63/1458

(57) ABSTRACT

Methods, systems, and apparatus, including computer programs encoded on computer storage media, for ranking a plurality of blockchain computer protocols executing on a blockchain in a time period by ranking a plurality of computing nodes according to a metric in the time period; designating a number of the top-ranked computing nodes from the plurality of computing nodes as evaluating computing nodes; calculating a protocol score for each of the plurality of blockchain computer protocols, and ranking the plurality of the blockchain computer protocols based on the respective protocol scores.

### BACKGROUND

A distributed ledger system is a decentralized data storage system with data replicated and synced across multiple computing nodes. A blockchain is a continuously growing list of data records linked and secured using cryptographic technology. A blockchain can be managed by a distributed ledger system, i.e., a blockchain network, with each computing node in the distributed ledger system adhering to a blockchain protocol for inter-node communication and new blocks validation.

Furthermore, developers can write third-party blockchain computer protocols to facilitate and enforce transactions on the blockchain without a centralized policing body. The ecosystem of a blockchain network depends on the quality and number of blockchain computer protocols it hosts.

### SUMMARY

This specification describes a particular implementation of a method for evaluating blockchain computer protocols. These technologies generally involve evaluating blockchain computer protocols based on the quality and usage traffic of the corresponding protocols in the blockchain network. The techniques can further include: ranking a plurality of blockchain computer protocols executing on a blockchain in a time period by ranking a plurality of computing nodes according to a metric in the time period; designating a number of the top-ranked computing nodes from the plurality of computing nodes as evaluating computing nodes; calculating a protocol score for each of the plurality of blockchain computer protocols, and ranking the plurality of the blockchain computer protocols based on the respective protocol scores.

Particular embodiments of the subject matter described in this specification can be implemented so as to realize one or more of the following advantages. Evaluating blockchain computer protocols provides a transparent and fair way to compare the quality of third-party applications executing on a blockchain, and encourages high-quality decentralized applications to be built on the blockchain. With more decentralized applications of better quality, a blockchain can provide more functionalities and enhanced security, thus attracting more users and developer.

The details of one or more embodiments of the subject matter of this specification are set forth in the accompanying drawing and description below. Other features, aspects, and advantages of the subject matter will become apparent from the description, the drawings, and the claims.

### BRIEF DESCRIPTION OF THE DRAWINGS

FIG. 1 is a schematic depiction of an example blockchain.

FIG. 2 is a schematic depiction of an example distributed ledger system.

FIG. 3 is a schematic depiction of an example blockchain computer protocol.

FIG. 4 is a flowchart of an example process for evaluating a blockchain computer protocol.

Specific embodiments of the invention will now be described in detail with reference to the accompanying figures. Like elements in the various figures are denoted by like reference numerals for consistency.

### DETAILED DESCRIPTION

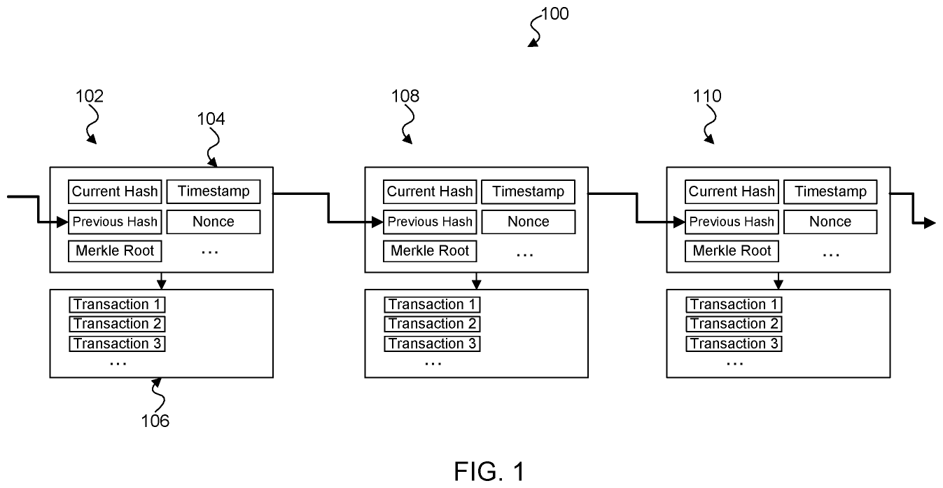

FIG. 1 is a schematic depiction of an example blockchain 100.

A blockchain is a linked list of blocks. Each block is a container data structure including at least (1) a block header and (2) a transaction list. For example, the blockchain 100 includes three example blocks, a block 102, a block 108, and a block 110 linked to each other.

A block header, e.g., the block header 104 for the block 102, includes metadata describing key aspects of the corresponding block. Example block header metadata include current hash, timestamp, previous hash, nonce, Merkle root, etc. Each of these metadata can be represented as a string value. For example, a block header can be represented by Table 1:

TABLE 1

| | |
|---|---|
| Current hash | “000000000000000000448b43be29890ca |
| | 780b2b21e2e2a0e53e04269d135abc8” |
| Previous hash | “0000000000000000002e22f7b842d8ec |
| | 98d67e5ae5041e263e3be7e3cea9bbb6” |
| Timestamp | “2018-04-30 19:02:08” |
| Nonce | “2069396004” |
| Merkle Root | “bcd5048e2c5a9960fb285dde4693a3ba |
| | 7830ea69b8cf9876214d31cd321f1dac” |

A transaction list, e.g., the transaction list 106 for the block 102, includes a list of transactions that occurred in a distributed ledger system, i.e., a peer-to-peer blockchain network that implements the blockchain. Each transaction in a transaction list occurred between the current timestamp and the time when the previous block was appended to the blockchain. An example transaction happens when one computing node, e.g., a transaction node, in the blockchain network, sends data, such as digital currency supported by the blockchain, to another computing node in the blockchain network. Another example transaction can include the distribution of digital currency to mining nodes by the blockchain network's consensus. Another example transaction can include a change of state of the current blockchain by the execution of a smart contract.

Each transaction can be described by (1) a sender address in the blockchain network, (2) a receiver address in the blockchain network, (3) transferred data, (4) a timestamp of the transaction, and (5) a unique transaction ID. Each of these fields can be represented as a string value. For example, a transaction can be represented by Table 2:

TABLE 2

| | |
|---|---|
| Sender Address | “134Qu1v9KenipLUCnZpC95GrBXh7S6vWog” |
| Receiver Address | “1FC6uZgnctM1BbVoQYZLCcN6o4KrgQZowE” |
| Timestamp | “2018-05-01 05:26:37” |
| Data | “0.6183096 BTC” |
| Transaction ID | “559dc5d4b58371da04c3719819e869a3b70bc |
| | 336145167d8bf662a480fece9bb” |

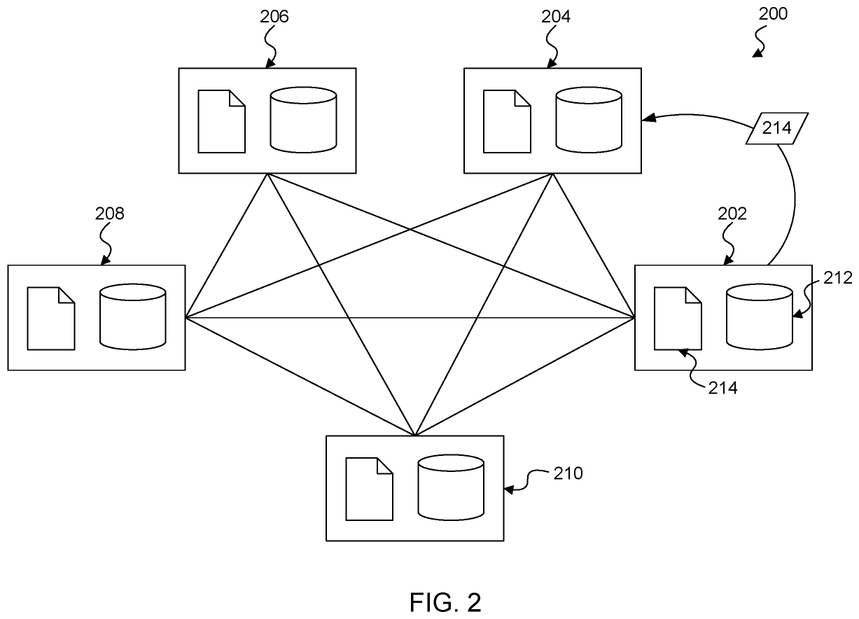

Each transaction will be broadcast to and validated in the blockchain network using a process called mining. Mining will be explained in more details below with reference to FIG. 2.

Current hash is a unique digital identifier of the current block. A hash is a cryptographic digital signature generated by feeding some selected data into a cryptographic hash function. A cryptographic hash function is a special class of hash functions that map data of arbitrary size to a bit string of a fixed size. For example, the cryptographic hash function used in table 1 has an output of a 32-bit string value. A cryptographic hash function useful for a blockchain is typically required to have five main properties:
1. It is deterministic so that the same data will result in the same hash.
2. It is quick to compute.
3. It is infeasible to recreate the data from its hash except by trying all possible messages.
4. A small change in the data will change the hash extensively.
5. It is infeasible to find two different data with the same hash value.

An example cryptographic hash function is the SHA-256 algorithm, which is used by the Bitcoin blockchain network. Other example cryptographic hash functions include BLAKE, BLAKE2, KECCAK-256, CryptoNight, etc.

Current hash is calculated by feeding block data, e.g., string values in the block header and the transaction list, to a cryptographic hash function specified in the blockchain protocol. Given that each block has unique block data and that it is infeasible to find two different data with the same hash value (property 5 mentioned above), current hash is unique for every block.

Previous hash is a hash pointer which points to the previous block. Previous hash has value equivalent to current hash of the previous block. As a result, except for the very first block, each block is connected to another block (the first block, or the “genesis block,” is generated automatically by the blockchain protocol). This design causes data on a blockchain to be immutable. For example, if a hacker wishes to change data in one block, data in all blocks must be changed since every block contains a bit of hashed information from another block, and a small change in the data will change the hash extensively.

Timestamp identifies the time when the current block was appended to the blockchain. Computing nodes can reference a dedicated time-reporting server to record consistent timestamp across the blockchain network.

Nonce is an arbitrary random value that is used in the cryptographic hash function to control the hash output. In order to add a new block to a blockchain, a special type of computing node “mining node” randomly chooses a nonce value and repeatedly hashes the block data including the chosen nonce till the hash output satisfies a specified condition. For example, the condition for adding a new block shown in table 1 is that the hash output (current hash) must have eighteen leading “0s.” Details on the process of adding a block to a blockchain are described below with reference to FIG. 2.

Merkle root is the top hash value produced by feeding data in a transaction list into a Merkle tree. A Merkle tree is a binary tree in which every leaf node is a hash of a data block and every non-leaf node is a hash of its two child nodes. Merkle root uniquely identifies the list of transactions associated with each block.

In some implementations, a reward is given to the mining node which first discovered a nonce to satisfy the specified condition for appending blocks. For example, the reward can be some digital currency specified by the blockchain. This incentives users to participate as mining nodes in the blockchain network to spend computing resources to compete in the so-called mining process described below. Each mining node maintains a copy of the blockchain locally, and communicates with other mining nodes to broadcast and validate new transactions.

FIG. 2 is a schematic depiction of an example distributed ledger system.

A distributed ledger system is a decentralized data storage system with data replicated and synced across multiple computing nodes. For example, a distributed ledger system can be implemented as a blockchain network. A blockchain network is a network of computing nodes set to maintain a blockchain, e.g., the blockchain 100 of FIG. 1, according to a specified blockchain protocol. For example, FIG. 2 shows a blockchain network 200 including five computing nodes 202, 204, 206, 208, and 210. Each computing node is independent from and connected to every other node. Computing nodes can assume different functions such as mining nodes, transaction nodes, decentralized applications, etc.

Each computing node includes a runtime that executes a specified blockchain protocol, e.g., a protocol 214 in the computing node 202. The blockchain protocol specifies rules including the conditions for allowing a mining node to add a new block to the blockchain, the frequency of adding new blocks, the type of data included in a block, or the amount of rewards to be distributed for appending the blockchain, etc.

Each computing node also includes a data storage area, e.g., a data storage area 212 of the computing node 202, for storing current information of the blockchain.

In some implementations, the blockchain network comprises one or more transaction nodes. Transaction nodes are a type of computing nodes in the blockchain network that do not implement the full blockchain protocol. For example, a transaction node does not spend computing resource to validate other transactions, but rely on mining nodes for such a task. A transaction node functions exclusively to send and receive data in the blockchain network with other computing nodes.

A transaction in the blockchain network is initiated when a transfer of data occurs. For example, the blockchain maintained in the blockchain network 200 can be a record of digital currency transactions among computing nodes. Each of the computing nodes 202, 204, 206, 208 and 210 can act as a transaction node and/or a mining node. That is to say, each of the computing nodes in FIG. 2 can both send and receive data, and validate new blocks to the blockchain. The computing node 202 can initiate a transaction 214 by sending some amount of digital currency to the computing node 204.

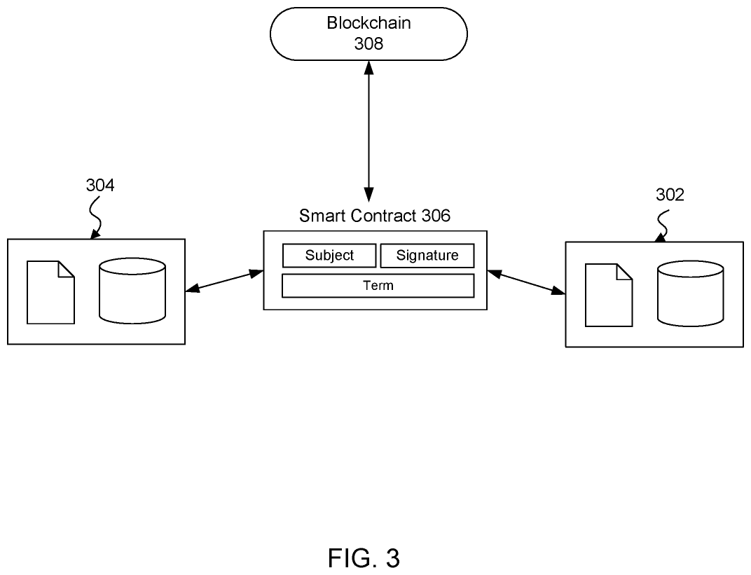

To have the blockchain record the transaction 214, the computing node 202 broadcasts this transaction to every other computing node in the blockchain network 200. Another computing node, e.g., the computing node 210, receives the transaction and performs two different tasks. First, the computing node 210 will verify that the transaction 214 is a valid transaction. For example, the computing node 210 can look into records in the existing blockchain to verify that the computing node 202 has the sufficient amount of digital currency to transfer to the computing node 204. Next, the computing node 210 participates in a mining process in an attempt to become one of the nodes that receive the authority to add this transaction to the blockchain, i.e., a validator node. For example, the mining process is administered according to a proof-of-devotion consensus algorithm described in FIG. 3 and the related description.

In some implementations, to become a validator node to participate in the mining process, a computing node spends computing resource to search for a special string (nonce) that causes the hash output of the block (current hash) to satisfy a specified condition. If a computing node is the first node to find the appropriate nonce, then the computing node becomes elected and is given certain rewards for validating the transaction and appending the transaction to the blockchain. Each computing node's mining power is limited by its specific computer architecture. For example, a computing node with a faster CPU clock rate has greater mining power compared to one with a slower clock rate.

As an example condition, for a block with some new transactions to be added to the blockchain, a nonce must be found such that when the nonce combined with other data in the block header and transaction list, and fed to the cryptographic hash function (e.g. SHA-256), the output string must begin with a certain number of leading “0s.” Since it is infeasible to recreate the data from its hash except by trying all possible inputs (property 3 of hash function), there only exists a brute force solution and it takes a very large number of trials to find the right nonce.

In some implementations, to become a validator node to participate in the mining process, a computer node is first ranked in the blockchain network based on a metric, and the computing node's probability to become a validator node is proportional to its rank in the blockchain network. For example, the metric can be a computing node's net possession of digital currency used in the blockchain network. Therefore, a computing node's probability to become a validator node is proportional to the amount of digital currency held by the computing node. A computing node that holds 1% of all available digital currency supported by the blockchain network has 1% chance of becoming a validator node. In another example, the metric can be a computing node's net transaction amount in a past time period.

In some implementations, a computer node becomes a validator node to participate in the mining process according to the example process illustrated in FIG. 3.

FIG. 3 is a schematic depiction of an example blockchain computer protocol 306. A blockchain computer protocol is also known as a smart contract. A smart contract is a piece of code that facilitates and enforces transactions on a blockchain without a centralized policing body. The transaction result is then recorded on the blockchain and becomes immutable. For example, a smart contract can manage agreements among computing nodes in a blockchain network, can provide services to other smart contracts, or can store information for a decentralized application on the blockchain.

In FIG. 3, computing nodes 302 and 304 are executing the smart contract 306 on a blockchain 308. The smart contract includes at least a subject, a signature, and a term to facilitate an exchange of data, e.g., digital currency, between computing nodes 304 and 302.

The subject of the smart contract defines the exchange medium. For example, the subject can be the digital currency supported by the corresponding blockchain. The smart contract can lock and re-distribute the subject according to the terms.

The signature of the smart contract provides a proof of authorization by the participating computing nodes. For example, in order to execute the smart contract 306, each of the computing nodes 304 and 302 first sign the smart contract 306 with a respective private key. Signing with the private key provides evidence that the computing node has voluntarily entered an agreement.

The term of a smart contract specifies a business logic for the entered agreement. For example, the term can include conditions and corresponding results. The term can include a call to a service that provides a measurement of a condition.

For example, the term of smart contract 306 can include the following logic: at 12:00 PM on Sep. 4, 2018, the computing node 304 will provide X amount of digital currency to the computing node 302. To execute this smart contract, the term of the contract calls a service on the blockchain that measures time. When the computing nodes both signed the smart contract, and it was the specified time, X amount of digital currency will be transferred as described in the term and recorded on the blockchain 308. This transaction is then verified by the blockchain network as described in FIG. 2.

In some implementations, any computing node in the blockchain network has the ability to draft and deploy new smart contracts. Different blockchains may support one or more different programming languages for smart contract development. For example, the Nebulas blockchain supports smart contract development in JavaScript.

In some implementations, the blockchain network can implement a search engine for smart contract search. The search engine can be a centralized search engine running on a designated computing node, e.g., the ElasticSearch engine, or it can be a decentralized application running on multiple computing nodes. A crawler can collect information on the blockchain and return the information to the search engine for ranking and indexing. Information collected can include block information, smart contract terms, comments from developer forums, or other news sources.

In some implementations, the smart contract search engine provides the ability to return smart contracts with similar functions. For example, the smart contract search engine can return similar smart contracts executing on the blockchain based on contract features. For example, contract features can include term text, structure, syntax from different dimensions, skeleton tree, type signature, or library calls. In the case of the skeleton tree, each smart contract is perceived as a tree-structured data of loops and conditional statements. The similarity between two smart contracts is measured using the tree edit distance, which is defined as the minimum-cost sequence of node edit operations that transform one tree into another. In some implementations, the edit distance between two smart contract tree structured data dₜ(T₁, T₂) can be represented as:

$${d}_{r} ( {T}_{1} , {T}_{2} ) = \frac{size ( {T}_{1} ) - size ( {T}_{2} )}{max ( size ( {T}_{1} ) , size ( {T}_{2} ) )}$$

$${d}_{t} ( {T}_{1} , {T}_{2} ) = \{ \begin{matrix}{d}_{r} ( {T}_{1} , {T}_{2} ) & if {d}_{r} ( {T}_{1} , {T}_{2} ) \geq {D}_{T} \\ \frac{max ( \begin{matrix}ed ( pre ( {T}_{1} ) , pre ( {T}_{2} ) ) , \\ ed ( post ( {T}_{1} ) , post ( {T}_{2} ) )\end{matrix} )}{max ( size ( {T}_{1} ) , size ( {T}_{2} ) )} & otherwise\end{matrix}$$

Where T1 and T2 are tree-structured data for smart contracts, D_{T} is a specified threshold value of an edit distance, pre(T) represents a pre-order traversal sequence of a smart contract tree structured data, post(T) represents a post-order traversal sequence of a smart contract tree structured data, and ed(X,Y) represents an edit distance between two traversal sequences X and Y. A small dₜ(T₁, T₂) means that T₁ and T₂ are similar to each other

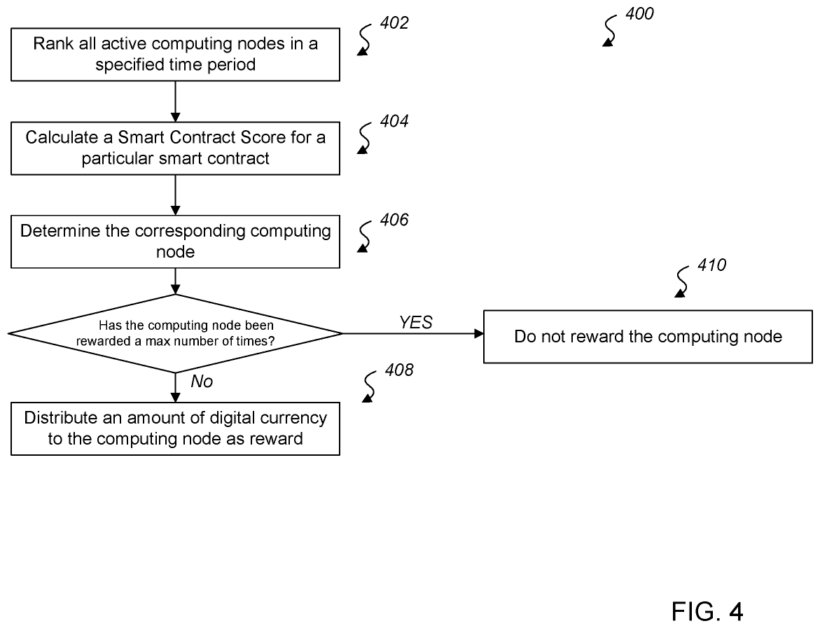

FIG. 4 is a flowchart of an example process 400 for evaluating a blockchain computer protocol. The process 400 includes a developer incentive plan (DIP) for evaluating smart contracts and distributing digital currency to developers based on the quality of the corresponding smart contracts. The DIP is a program that automatically assesses the quality of a smart contract, and rewards the computing node that created and deployed the smart contract based on the quality assessment. The DIP can be executed as a centralized or decentralized application on the blockchain. In particular, the DIP can be executed by one or more computers, located in one or more locations, and programmed appropriately in accordance with this specification.

The DIP first ranks all active computing nodes for a blockchain in a specified time period based on a metric (402). A computing node is active in the specified time period if it made at least one transaction, e.g., exchanging digital currency with another computing node. Example metrics include the amount of digital currency possessed by each computing node, the number of transactions committed by each computing node, the computing power of each computing node, etc.

The DIP then calculates a smart contract score (SCS) for a particular smart contract (404). The DIP performs the calculation based on (1) the number of active computing nodes that have engaged with the smart contract in the time period, and (2) the rank of those engaging computing nodes. In some implementations, information related to smart contract engagement is recorded on the blockchain as transactions. The SCS is calculated according to the following formula:

$$SCS = {\sum }_{Engaging Computing Nodes}^{ } ( max \{ X + 1 - Rank ( Engaging Computing Nodes ) , 0 \} )$$

where X is a parameter specified by the DIP, and designates a number of the top-ranked computing nodes.

For example, a DIP can use the top-five ranked active computing nodes to compute the SCS, thus making X=5. If only one of the five computing nodes has engaged with the smart contract in the specified time period, and the engaging computing node is the top-ranked computing node, the SCS for this smart contract is 5. Similarly, if a second smart contract has been engaged with two computing nodes that ranked first and second of the five computing nodes, the second smart contract has an SCS of 9.

In some implementations, the blockchain network can use smart contract scores to defend against Distributed Denial of Service Attacks (DDoS attacks). In some cases, a malicious computing node can deploy multiple smart contracts in the blockchain network and coordinate multiple other malicious computing nodes to call those smart contracts to initiate a DDoS attack. Since calling a smart contract triggers a transaction to be registered on the blockchain, the DDoS attack can cause a large number of fake transactions to jam the blockchain network and prevent real transactions from being registered on the blockchain.

To defend against a DDoS attack, the blockchain network can temporarily disable smart contracts having SCS below a threshold value. As a result, the malicious computing nodes are unable to jam the blockchain network by calling these malicious smart contracts.

With the SCS determined, the DIP then determines the computing node that was responsible for creating the corresponding smart contract (406). If the computing node has not been rewarded to a maximum number of times in a specified time period, the DIP then calculates an amount of digital currency to be distributed to the computing node (408). in some implementations, the amount of digital currency is calculated using the following set of equations:

$$Coin ( C ) = k \cdot ln ( N + 1 - SCR ( C ) ) + b$$

$$k \cdot ln ( N ) = b$$

$${\sum }_{X}^{N} ( k \cdot ln ( x ) + b ) = M$$

where C designates the smart contract, Coin (C) designates the amount of digital currency to be distributed to the computing node responsible for creating C, N designates the net number of smart contracts to be rewarded in the time period, SCR (C) designates the smart contract score of C, b is a constant, M is the total amount of digital currency to be distributed for all smart contracts in the time period, k is the maximum number of times that a smart contract can get rewarded, and In is the natural logarithm function:

M and b are specified as parameters in the DIP. As a result, a computing node responsible for creating the top-ranked smart contract is rewarded twice as much digital currency as the computing node responsible for creating the Nth-ranked smart contract.

In some implementations, the reward M comes from a reserved pool of digital currency from the blockchain. For example, the reserved pool can be fixed in size and will deplete after a number of rewarding cycles. Alternatively, the reserved pool can be continuously replenished by taking a portion of transaction fees on the blockchain.

The DIP improves the ecosystem of the blockchain by attracting more people to trust and build applications on the blockchain. Furthermore, as part of the DIP, each smart contract is assigned a smart contract score. The smart contract score is calculated in a decentralized way and provides a fair and truthful assessment of the quality of each deployed smart contract.

In some implementations, the smart contract scores and the distribution of digital currency in each time period are recorded as transactions in a block on the blockchain. The block is viewable to all computing nodes in the blockchain network.

Embodiments of this specification include methods and corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the operations described in this document can be implemented in digital electronic circuitry, or in computer software, firmware, or hardware, including the structures, disclosed in this document and their structural equivalents, or in combinations of one or more of them. Embodiments of the subject matter described in this document can be implemented as one or more computer programs, i.e., one or more modules of computer program instructions encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
ranking a plurality of smart contracts executing on a blockchain in a time period, wherein the blockchain comprises a plurality of computing nodes, wherein each of the smart contracts is deployed by one of the plurality of computing nodes, and wherein ranking the plurality of smart contracts comprises:
ranking the plurality of computing nodes according to a metric in the time period;
designating a number of the top-ranked computing nodes from the plurality of computing nodes as evaluating computing nodes in the time period;
calculating a smart contract score for each of the plurality of smart contracts, comprising:
determining a sub-score for each computing node that has engaged with the respective smart contract in the time period by subtracting the rank of the respective engaging computing node from the number of the evaluating computing nodes plus one, and wherein in response to the sub-score being a negative number, designating the sub-score to be zero; and
designating the sum of all sub-scores as the smart contract score for the respective smart contract; and
ranking the plurality of smart contracts based on the respective smart contract scores.

2. The method of claim 1, further comprising:
distributing an amount of digital currency supported by the blockchain to each of the computing node that has deployed a respective smart contract, wherein the amount of digital currency distributed depends on the smart contract score of the respective smart contract.

3. The method of claim 2, wherein each computing node can only receive digital currency up to a certain number of times.

4. The method of claim 2, wherein the amount of digital currency distributed to each computing node is calculated based on the following set of equations:
$$Coin ( C ) = k \cdot ln ( N + 1 - SCR ( C ) ) + b ¶$$
$$k \cdot ln ( N ) = b ¶$$
$${\sum }_{X}^{N} ( k \cdot ln ( x ) + b ) = M ¶$$
wherein Coin (C) is the amount of digital currency to be distributed to a computing node that is responsible for deploying a smart contract C, wherein N is the total number of smart contracts to be ranked in the time period, wherein SCR (C) is the smart contract score of the smart contract C, wherein b is a constant, wherein k is the max number of times a smart contract can receive rewards in a time period, wherein ln( ) is the natural logarithm function, and wherein M is the total amount of digital currency to be distributed in the time period.

5. The method of claim 1, further comprising in response to a distributed denial of service attack (DDoS attack), temporarily disabling smart contracts with smart contract scores below a threshold value.

6. The method of claim 1, wherein the ranking of the plurality of smart contracts is recorded as a transaction in a block on the blockchain.

7. The method of claim 2, wherein the distribution of digital currency to the computing nodes that has deployed a respective smart contract is recorded as a transaction in a block on the blockchain.

8. A system comprising one or more computers and one or more storage devices storing instructions that when executed by the one or more computers cause the one or more computers to perform operations comprising:
ranking a plurality of smart contracts executing on a blockchain in a time period, wherein the blockchain comprises a plurality of computing nodes, wherein each of the smart contracts is deployed by one of the plurality of computing nodes, and wherein ranking the plurality of smart contracts comprises:
ranking the plurality of computing nodes according to a metric in the time period;
designating a number of the top-ranked computing nodes from the plurality of computing nodes as evaluating computing nodes in the time period;
calculating a smart contract score for each of the plurality of smart contracts, comprising:
determining a sub-score for each computing node that has engaged with the respective smart contract in the time period by subtracting the rank of the respective engaging computing node from the number of the evaluating computing nodes plus one, and wherein in response to the sub-score being a negative number, designating the sub-score to be zero; and
designating the sum of all sub-scores as the smart contract score for the respective smart contract; and
ranking the plurality of smart contracts based on the respective smart contract scores.

9. The system of claim 8, wherein the operations further comprising:
distributing an amount of digital currency supported by the blockchain to each of the computing node that has deployed a respective smart contract, wherein the amount of digital currency distributed depends on the smart contract score of the respective smart contract.

10. The system of claim 9, wherein each computing node can only receive digital currency up to a certain number of times.

11. The system of claim 9, wherein the amount of digital currency distributed to each computing node is calculated based on the following set of equations:
$$Coin ( C ) = k \cdot ln ( N + 1 - SCR ( C ) ) + b ¶$$
$$k \cdot ln ( N ) = b ¶$$
$${\sum }_{X}^{N} ( k \cdot ln ( x ) + b ) = M ¶$$
wherein Coin (C) is the amount of digital currency to be distributed to a computing node that is responsible for deploying a smart contract C, wherein N is the total number of smart contracts to be ranked in the time period, wherein SCR (C) is the smart contract score of the smart contract C, wherein b is a constant, wherein k is the max number of times a smart contract can receive rewards in a time period, wherein ln( ) is the natural logarithm function, and wherein M is the total amount of digital currency to be distributed in the time period.

12. The system of claim 8, wherein the operations further comprising: in response to a distributed denial of service attack (DDoS attack), temporarily disabling smart contracts with smart contract scores below a threshold value.

13. The system of claim 8, wherein the ranking of the plurality of smart contracts is recorded as a transaction in a block on the blockchain.

14. The system of claim 9, wherein the distribution of digital currency to the computing nodes that has deployed a respective smart contract is recorded as a transaction in a block on the blockchain.

15. A non-transitory computer storage medium encoded with a computer program, the computer program storing instructions that when executed by one or more computers cause the one or more computers to perform operations comprising:
ranking a plurality of smart contracts executing on a blockchain in a time period, wherein the blockchain comprises a plurality of computing nodes, wherein each of the smart contracts is deployed by one of the plurality of computing nodes, and wherein ranking the plurality of smart contracts comprises:
ranking the plurality of computing nodes according to a metric in the time period;
designating a number of the top-ranked computing nodes from the plurality of computing nodes as evaluating computing nodes in the time period;
calculating a smart contract score for each of the plurality of smart contracts, comprising:
determining a sub-score for each computing node that has engaged with the respective smart contract in the time period by subtracting the rank of the respective engaging computing node from the number of the evaluating computing nodes plus one, and wherein in response to the sub-score being a negative number, designating the sub-score to be zero; and
designating the sum of all sub-scores as the smart contract score for the respective smart contract; and
ranking the plurality of smart contracts based on the respective smart contract scores.

16. The non-transitory computer storage medium of claim 15, wherein the operations further comprising:
distributing an amount of digital currency supported by the blockchain to each of the computing node that has deployed a respective smart contract, wherein the amount of digital currency distributed depends on the smart contract score of the respective smart contract.

17. The non-transitory computer storage medium of claim 16, wherein each computing node can only receive digital currency up to a certain number of times.

18. The non-transitory computer storage medium of claim 16, wherein the amount of digital currency distributed to each computing node is calculated based on the following set of equations:
$$Coin ( C ) = k \cdot ln ( N + 1 - SCR ( C ) ) + b ¶$$
$$k \cdot ln ( N ) = b ¶$$
$${\sum }_{X}^{N} ( k \cdot ln ( x ) + b ) = M ¶$$
wherein Coin (C) is the amount of digital currency to be distributed to a computing node that is responsible for deploying a smart contract C, wherein N is the total number of smart contracts to be ranked in the time period, wherein SCR (C) is the smart contract score of the smart contract C, wherein b is a constant, wherein k is the max number of times a smart contract can receive rewards in a time period, wherein ln( ) is the natural logarithm function, and wherein M is the total amount of digital currency to be distributed in the time period.

19. The non-transitory computer storage medium of claim 15, further comprising in response to a distributed denial of service attack (DDoS attack), temporarily disabling smart contracts with smart contract scores below a threshold value.

20. The non-transitory computer storage medium of claim 15, wherein the ranking of the plurality of smart contracts is recorded as a transaction in a block on the blockchain.
